(19) United States
(12) Patent Application Publication
(10) Pub. No.: US 2026/0360101 A1
(43) Pub. Date: Nov. 12, 2026

(54) TARGET OBJECT DETECTION APPARATUS, TARGET OBJECT DETECTION METHOD, AND NON-TRANSITORY COMPUTER-READABLE MEDIUM

(71) Applicant: NEC Corporation, Tokyo (JP)

(72) Inventors: Shingo YAMANOUCHI, Tokyo (JP); Toshiyuki NOMURA, Tokyo (JP); Masayuki ARIYOSHI, Tokyo (JP)

(73) Assignee: NEC Corporation, Tokyo (JP)

(21) Appl. No.: 19/135,510

(22) PCT Filed: Dec. 6, 2023
(86) PCT No.: PCT/JP2023/043656

§ 371 Date: Jun. 4, 2025

(30) Foreign Application Priority Data
Dec. 12, 2022 (JP) 2022-197899

(51) Int. Cl. G06V 10/25; G01S 13/89

(52) U.S. Cl. CPC G06V 10/25; G01S 13/89; G06V 2201/07

(57) ABSTRACT

The present invention provides a target object detection apparatus including: an image generation unit that generates a reflected wave image, based on a reception signal of an electromagnetic wave reflected on a target object; and a likelihood map generation unit that generates, based on intensity of the reception signal indicated by the reflected wave image, a first likelihood map indicating a likelihood with which each pixel of the reflected wave image is associated with an irregularly-shaped target object that shields a background object and whose reflectivity of an electromagnetic wave is different from that of the background object, and also generates, based on a shape of an object indicated by the reflected wave image, a second likelihood map indicating a likelihood with which each pixel of the reflected wave image is associated with a predefined fixed-shaped target object.

### TECHNICAL FIELD

The present invention relates to a target object detection apparatus, a target object detection method, and a program.

### BACKGROUND ART

A technique related to the present invention is disclosed in Patent Documents 1 to 4. The techniques disclosed in Patent Documents 1 to 4 is related to a belongings inspection using an electromagnetic wave.

The technique disclosed in Patent Document 1 is directed to inspecting, based on data related to intensity or a depth along a surface of a target object, whether a target person carries an artificial object being suspected to be a contraband object or a safety threat (an explosive or the like).

Patent Document 2 discloses that, since X-ray reflectivity is different between an object and a human tissue, there is a possibility that an object can be visually recognized within an X-ray image of a human body.

The technique disclosed in Patent Document 3 is directed to identifying a kind of an object to be detected included in a detection target object from a difference between a signal of radiant energy to be irradiated from the object to be detected, and a signal of radiant energy of the detection target object in a vicinity of a non-detection object. The technique disclosed in Patent Document 3 can perform an inspection of substance in a wide range from powder to solid such as a metal.

Patent Document 4 discloses that, since reflectivity is different between an electromagnetic wave reflected on a human body, and an electromagnetic wave reflected on a concealed object inside clothing, it is possible to detect a concealed object, based on the difference.

### RELATED DOCUMENT

### Patent Document

Patent Document 1: Japanese Patent Application Publication (Translation of PCT Application) No. 2007-517275

Patent Document 2: Japanese Patent Application Publication (Translation of PCT Application) No. 2010-530977

Patent Document 3: Japanese Patent Application Publication No. 2017-40593

Patent Document 4: Japanese Patent Application Publication No. 2021-32778

### DISCLOSURE OF THE INVENTION

### Technical Problem

In a belongings inspection, there is a case where both of a fixed-shaped target object whose shape is fixed, and an irregularly-shaped target object whose shape is not fixed become a detection target. The fixed-shaped target object is, for example, a gun, a knife, and the like. The irregularly-shaped target object is, for example, liquid matter, powder matter, and the like. In view of the above, a technique capable of accurately detecting both of a fixed-shaped target object and an irregularly-shaped target object has been required.

According to the techniques described in Patent Documents 1 to 4, it is possible to detect a target object in a wide range. However, in these techniques, both of a fixed-shaped target object and an irregularly-shaped target object are detected by the same method. Detection accuracy may be lowered, unless a method suitable for each of the target objects is utilized.

One example of an object of the present invention is, in view of the above problem, to provide a target object detection apparatus, a target object detection method, and a program that solve a task of accurately detecting both of a fixed-shaped target object and an irregularly-shaped target object.

### Solution to Problem

One example aspect of the present invention provides a target object detection apparatus including:
an image generation unit that generates a reflected wave image, based on a reception signal of an electromagnetic wave reflected on a target object; and
a likelihood map generation unit that generates, based on intensity of the reception signal indicated by the reflected wave image, a first likelihood map indicating a likelihood with which each pixel of the reflected wave image is associated with an irregularly-shaped target object that shields a background object and whose reflectivity of an electromagnetic wave is different from that of the background object, and also generates, based on a shape of an object indicated by the reflected wave image, a second likelihood map indicating a likelihood with which each pixel of the reflected wave image is associated with a predefined fixed-shaped target object.

One example aspect of the present invention provides a target object detection method including,
by one or more computers:
   generating a reflected wave image, based on a reception signal of an electromagnetic wave reflected on a target object; and
   generating, based on intensity of the reception signal indicated by the reflected wave image, a first likelihood map indicating a likelihood with which each pixel of the reflected wave image is associated with an irregularly-shaped target object that shields a background object and whose reflectivity of an electromagnetic wave is different from that of the background object, and also generates, based on a shape of an object indicated by the reflected wave image, a second likelihood map indicating a likelihood with which each pixel of the reflected wave image is associated with a predefined fixed-shaped target object.

One example aspect of the present invention provides a program causing a computer to function as:
an image generation unit that generates a reflected wave image, based on a reception signal of an electromagnetic wave reflected on a target object; and
a likelihood map generation unit that generates, based on intensity of the reception signal indicated by the reflected wave image, a first likelihood map indicating a likelihood with which each pixel of the reflected wave image is associated with an irregularly-shaped target object that shields a background object and whose reflectivity of an electromagnetic wave is different from that of the background object, and also generates, based on a shape of an object indicated by the reflected wave image, a second likelihood map indicating a likelihood with which each pixel of the reflected wave image is associated with a predefined fixed-shaped target object.

### Advantageous Effect of Invention

According to one example aspect of the present invention, a target object detection apparatus, a target object detection method, and a program that solve a task of accurately detecting both of a fixed-shaped target object and an irregularly-shaped target object are achieved.

### BRIEF DESCRIPTION OF THE DRAWINGS

The above-described object, the other objects, features, and advantages will become more apparent from a public example embodiment described below and the following accompanying drawings.

FIG. 1 It is a diagram illustrating one example of a functional block diagram of a target object detection apparatus.

FIG. 2 It is a diagram for describing a feature of a learning model utilized by the target object detection apparatus.

FIG. 3 It is a diagram for describing a comparative example.

FIG. 4 It is a diagram illustrating one example of a hardware configuration of the target object detection apparatus.

FIG. 5 It is a diagram illustrating one example of a functional block diagram of the target object detection apparatus.

FIG. 6 It is a diagram illustrating one example of a reflective wave image to be generated by the target object detection apparatus.

FIG. 7 It is a diagram illustrating one example of a set of likelihood maps to be generated by the target object detection apparatus.

FIG. 8 It is a diagram illustrating another example of a set of likelihood maps to be generated by the target object detection apparatus.

FIG. 9 It is a diagram illustrating one example of a functional block diagram of a learning apparatus.

FIG. 10 It is a flowchart illustrating one example of a flow of processing of the target object detection apparatus.

FIG. 11 It is a diagram illustrating another example of a functional block diagram of the target object detection apparatus.

FIG. 12 It is a diagram illustrating another example of a function block diagram of the target object detection apparatus.

FIG. 13 It is a diagram illustrating one example of a first image and a second image to be generated by the target object detection apparatus.

FIG. 14 It is a diagram illustrating another example of a first image and a second image to be generated by the target object detection apparatus.

FIG. 15 It is a flowchart illustrating one example of a flow of processing of the target object detection apparatus.

### EXAMPLE EMBODIMENT

Hereinafter, example embodiments according to the present invention are described by using the drawings. Note that, in all drawings, a similar constituent element is indicated by a similar reference sign, and description thereof is omitted as necessary.

### First Example Embodiment

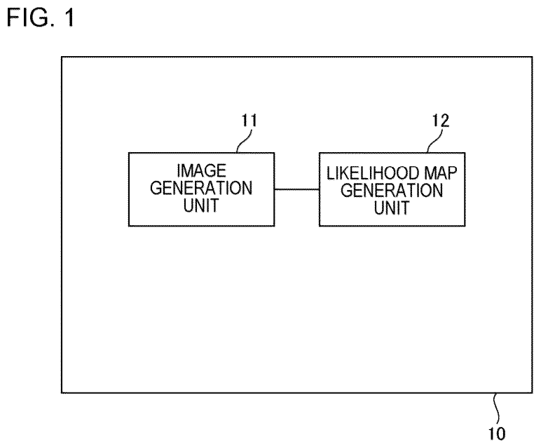

FIG. 1 is a functional block diagram illustrating an overview of a target object detection apparatus 10 according to a first example embodiment. The target object detection apparatus 10 includes an image generation unit 11, and a likelihood map generation unit 12.

The image generation unit 11 generates a reflected wave image, based on a reception signal of an electromagnetic wave reflected on a target object.

The likelihood map generation unit 12 generates a first likelihood map, and a second likelihood map.

The first likelihood map indicates a likelihood with which each pixel of a reflected wave image is associated with an irregularly-shaped target object (hereinafter, may be simply referred to as an “irregularly-shaped target object”) that shields a background object and whose reflectivity of an electromagnetic wave is different from that of the background object.

Specifically, the first likelihood map indicates a likelihood with which each pixel of the reflected wave image indicates intensity of a reflected wave reflected on the irregularly-shaped target object. The likelihood map generation unit 12 generates the first likelihood map, based on intensity of a reception signal indicated by the reflected wave image, by utilizing a difference between reflectivity of an electromagnetic wave of the background object, and reflectivity of an electromagnetic wave of the irregularly-shaped target object.

The second likelihood map indicates a likelihood with which each pixel of a reflected wave image is associated with a predefined fixed-shaped target object. Specifically, the second likelihood map indicates a likelihood with which each pixel of the reflected wave image indicates intensity of a reflected wave reflected on the fixed-shaped target object. The likelihood map generation unit 12 generates the second likelihood map by utilizing a shape of an object indicated by the reflected wave image.

In the target object detection apparatus 10 according to the first example embodiment as above, an irregularly-shaped target object is detected, based on intensity of a reception signal indicated by a reflected wave image, by utilizing a difference between reflectivity of an electromagnetic wave of a background object, and reflectivity of an electromagnetic wave of the irregularly-shaped target object. Further, a fixed-shaped target object is detected by utilizing a shape of an object indicated by the reflected wave image. In the target object detection apparatus 10 according to the first example embodiment as above, a task of accurately detecting both of a fixed-shaped target object, and an irregularly-shaped target object is solved.

### Second Example Embodiment

### “Overview”

A target object detection apparatus 10 according to a second example embodiment is an apparatus in which a configuration of the target object detection apparatus 10 according to the first example embodiment is embodied. The target object detection apparatus 10 according to the second example embodiment includes a configuration similar to that of the target object detection apparatus 10 according to the first example embodiment, and achieves an advantageous effect similar to that of the target object detection apparatus 10 according to the first example embodiment. Further, the target object detection apparatus 10 according to the second example embodiment includes the following features.

As described in the first example embodiment, the target object detection apparatus 10 generates each of a first likelihood map indicating a likelihood with which each pixel of a reflected wave image is associated with an irregularly-shaped target object, and a second likelihood map indicating a likelihood with which each pixel of the reflected wave image is associated with a fixed-shaped target object.

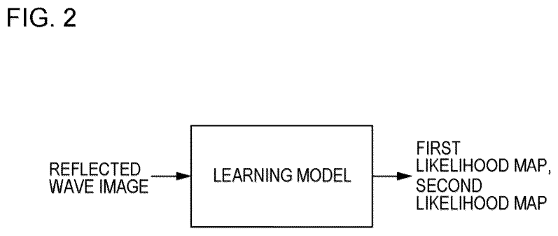

Further, the target object detection apparatus 10 generates both of the first likelihood map and the second likelihood map by using a learning model being generated in advance. As illustrated in FIG. 2, the learning model accepts an input of a reflected wave image. Further, the learning model generates and outputs both of the first likelihood map and the second likelihood map individually in response to the input of the reflected wave image.

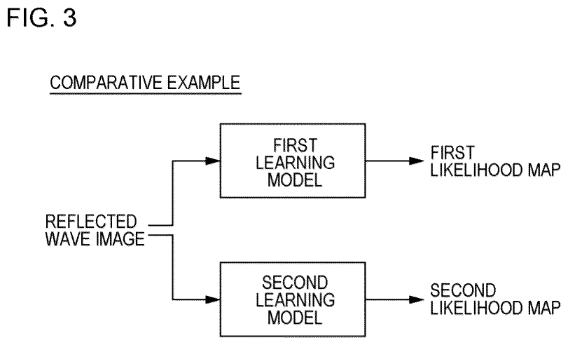

FIG. 3 illustrates a configuration of a comparative example. In the comparative example, two learning models being a first learning model that generates a first likelihood map in response to an input of a reflected wave image, and a second learning model that generates a second likelihood map in response to an input of the reflected wave image are utilized.

Specifically, in the comparative example, the first likelihood map and the second likelihood map are generated by using the two learning models. In a case of a configuration of the comparative example as described above, there is a problem such as an increase in resources of a computer.

In the target object detection apparatus 10 according to the second example embodiment, the problem as described above can be reduced.

Hereinafter, a configuration of the target object detection apparatus 10 according to the second example embodiment is described in detail.

### “Hardware Configuration”

Next, one example of a hardware configuration of the target object detection apparatus 10 is described. Each functional unit of the target object detection apparatus 10 is achieved by any combination of hardware and software. It is understood by a person skilled in the art that there are various modification examples as a method and an apparatus for achieving the configuration. The software includes a program stored in advance at a shipping stage of an apparatus, a program downloaded from a medium such as a compact disc (CD), a server on the Internet, and the like, and the like.

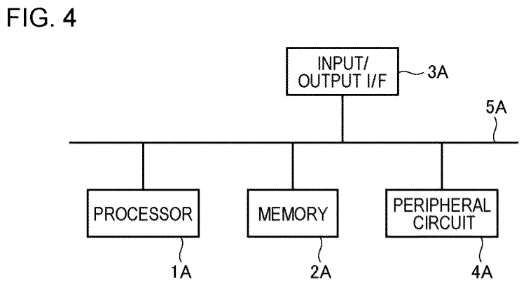

FIG. 4 is a block diagram illustrating a hardware configuration of the target object detection apparatus 10. As illustrated in FIG. 4, the target object detection apparatus 10 includes a processor 1A, a memory 2A, an input/output interface 3A, a peripheral circuit 4A, and a bus 5A. The peripheral circuit 4A includes various modules. The target object detection apparatus 10 may not include the peripheral circuit 4A. Note that, the target object detection apparatus 10 may be configured by a plurality of apparatuses being physically and/or logically separated. In this case, each of the plurality of the apparatuses can include the above-described hardware configuration.

The bus 5A is a data transmission path along which the processor 1A, the memory 2A, the peripheral circuit 4A, and the input/output interface 3A mutually transmit and receive data. The processor 1A is an arithmetic processing apparatus such as, for example, a CPU and a graphics processing unit (GPU). The memory 2A is a memory such as, for example, a random access memory (RAM) and a read only memory (ROM). The input/output interface 3A includes an interface for acquiring information from an input apparatus, an external apparatus, an external server, an external sensor, a camera, and the like, an interface for outputting information to an output apparatus, an external apparatus, an external server, and the like, and the like.

Further, the input/output interface 3A includes an interface for connecting to a communication network such as the Internet. The input apparatus is, for example, a keyboard, a mouse, a microphone, a physical button, a touch panel, and the like. The output apparatus is, for example, a display, a speaker, a printer, a mailer, and the like. The processor 1A can issue a command to each module, and perform an arithmetic operation, based on an arithmetic operation result of each module.

“functional Configuration”

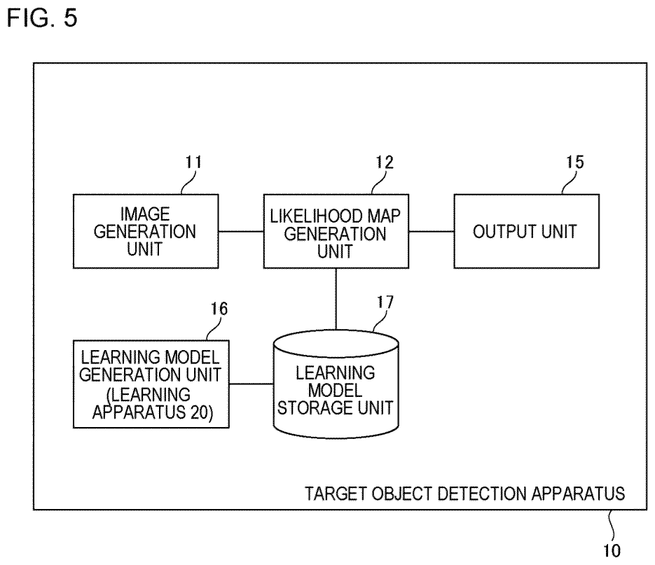

Next, a functional configuration of the target object detection apparatus 10 according to the second example embodiment is described in detail. FIG. 5 illustrates one example of a functional block diagram of the target object detection apparatus 10. As illustrated in FIG. 5, the target object detection apparatus 10 includes an image generation unit 11, a likelihood map generation unit 12, an output unit 15, a learning model generation unit 16, and a learning model storage unit 17.

The image generation unit 11 generates a reflected wave image, based on a reception signal of an electromagnetic wave reflected on a target object.

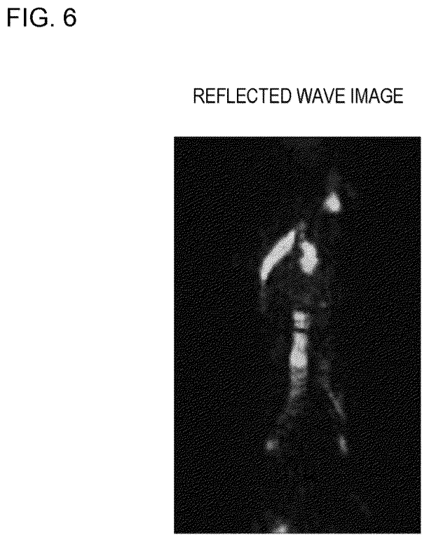

In the “reflected wave image”, each pixel indicates intensity (intensity of a reception signal) of an electromagnetic wave (reflected wave) reflected on a target object. FIG. 6 illustrates one example of the reflected wave image. A human body is indicated in the reflected wave image illustrated in FIG. 6. Generation of a reflected wave image based on a reception signal of an electromagnetic wave is achieved by using any known technique.

The “target object” is a human body, belongings carried by the human body, and the like. The target object detection apparatus 10 is utilized, for example, in a belongings inspection and the like. In this case, a human body of a person being a target for a belongings inspection, and belongings carried by the person become the target object.

The “reception signal of an electromagnetic wave” is generated by an electromagnetic wave transmitting and receiving apparatus. The target object detection apparatus 10 may include the electromagnetic wave transmitting and receiving apparatus. In addition, the electromagnetic wave transmitting and receiving apparatus may be another apparatus being physically and/or logically separated from the target object detection apparatus 10. Further, a reception signal of an electromagnetic wave generated by the electromagnetic wave transmitting and receiving apparatus may be input to the target object detection apparatus 10 by any means.

The electromagnetic wave transmitting and receiving apparatus controls a transmission antenna that irradiates an electromagnetic wave such as a millimeter wave, and a reception antenna that receives a reflected wave of the electromagnetic wave irradiated from the transmission antenna. The electromagnetic wave transmitting and receiving apparatus controls, for example, irradiation of an electromagnetic wave from the transmission antenna, specifically, irradiation timing and the like.

As an electromagnetic wave to be irradiated from the transmission antenna, for example, a continuous wave (CW), a frequency modulated continuous wave (frequency modulated CW (FMCW)), a stepped frequency continuous wave (SFCW), and the like can be used. The reception antenna measures complex amplitude (complex number representing a phase shift from amplitude and a transmitted wave) of a received wave for each frequency, and sets a measurement result, as a radar signal. The radar signal is represented as S(n, m, f), where a number n of a transmission antenna, a number m of a reception antenna, and a frequency f are set as an argument.

The configuration of the antenna is not specifically limited, and any configuration can be adopted. For example, an antenna panel in which a plurality of transmission antennas and a plurality of reception antennas are arranged may be adopted.

The plurality of antennas are installed at such a position and in such a direction that an electromagnetic wave is irradiated toward a target space, and a reflected wave reflected on a target object located within the target space is received.

The target space is a space in which a predetermined inspection such as a belongings inspection is performed. By the above-described antenna, irradiation of an electromagnetic wave toward a target space including a target object, and reception of a reflected wave of the electromagnetic wave are performed. Further, various inspections are performed based on a radar signal of the reflected wave. The target space is provided, for example, on a passage or the like through which a target object passes. Further, irradiation of an electromagnetic wave and reception of a reflected wave are performed while the target object is moving within the target space. In this way, in one example of the second example embodiment, a walkthrough-type inspection is achieved. In addition, the target space may be a space based on a premise that a target object stops for a certain time for an inspection.

Referring back to FIG. 5, the likelihood map generation unit 12 generates a first likelihood map and a second likelihood map.

The “first likelihood map” indicates a likelihood with which each pixel of a reflected wave image is associated with an irregularly-shaped target object that shields a background object and whose reflectivity of an electromagnetic wave is different from that of the background object. Specifically, the first likelihood map indicates a likelihood with which each pixel of the reflective wave image indicates intensity of a reflected wave reflected on the irregularly-shaped target object.

The likelihood map generation unit 12 generates the first likelihood map, based on intensity of a reception signal indicated by a reflected wave image, by utilizing a difference between reflectivity of an electromagnetic wave of a background object and reflectivity of an electromagnetic wave of an irregularly-shaped target object. The irregularly-shaped target object being a detection target overlaps the background object on the reflected wave image, and shields the background object. Further, reflectivity of an electromagnetic wave of the irregularly-shaped target object is different from reflectivity of an electromagnetic wave of the background object. Because of a feature as described above, in the reflected wave image, intensity of a reception signal on a part (a part shielded by the irregularly-shaped target object) of the background object is lowered, as compared with another part (a part not being shielded by the irregularly-shaped target object) thereof. Based on a phenomenon as described above, it is possible to compute a likelihood with which each pixel of a reflected wave image is associated with an irregularly-shaped target object.

The “background object” is, for example, a human body. The “irregularly-shaped target object” includes, for example, liquid matter or powder matter. The liquid matter is, for example, liquid and the like, of which possession, bringing to a facility, and the like are prohibited. The powder matter is a powdery object, of which possession, bringing to a facility, and the like are prohibited, and is, for example, a drug and the like.

The “second likelihood map” indicates a likelihood with which each pixel of a reflected wave image is associated with a predefined fixed-shaped target object. Specifically, the second likelihood map indicates a likelihood with which each pixel of the reflected wave image indicates intensity of a reflected wave reflected on the predefined fixed-shaped target object.

The likelihood map generation unit 12 generates the second likelihood map, based on a shape of an object indicated by a reflected wave image. A shape of the fixed-shaped target object is fixed. Therefore, it is possible to compute a likelihood with which each pixel of the reflected wave image is associated with a predefined fixed-shaped target object, based on a shape of an object indicated by the reflected wave image, and a shape of the predefined fixed-shaped target object.

The “fixed-shaped target object” includes a gun, a knife, or another weapon. Predetermined kinds of objects are defined in advance as the fixed-shaped target object. The number of the fixed-shaped target objects that are defined in advance may be one or plural.

The likelihood map generation unit 12 generates both of the first likelihood map and the second likelihood map individually in response to an input of a reflected wave image, and generates the first likelihood map and the second likelihood map, based on a learning model to be output (see FIG. 2).

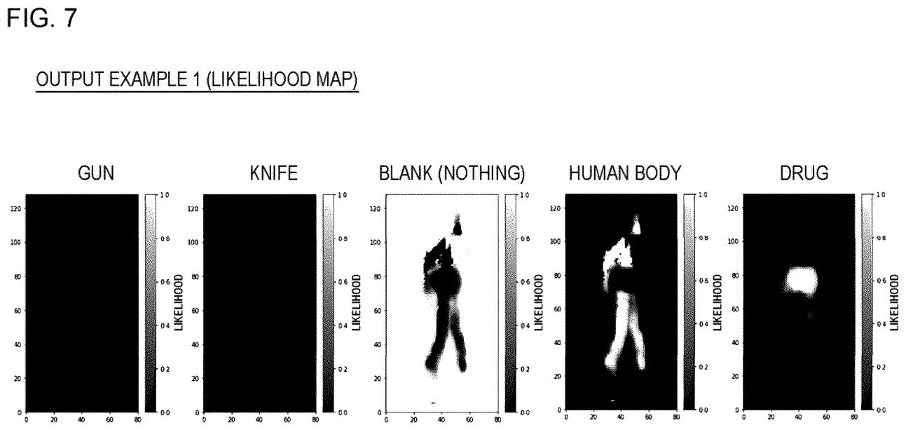

In response to an input of a reflected wave image to the learning model, for example, a plurality of likelihood maps as illustrated in FIG. 7 are output. In an example in FIG. 7, the learning model generates and outputs five likelihood maps in response to an input of a reflected wave image. Specifically, a likelihood map associated with each of a “gun”, a “knife”, “blank (nothing)”, a “human body”, and an “irregularly-shaped target object” is output. In FIG. 7, a likelihood of each kind of an associated target object is displayed in black and white shades, an area in which a likelihood is high is indicated in white, and an area in which a likelihood is low is indicated in black. In a case of the example illustrated in FIG. 7, two kinds, that is, the “gun”, and the “knife” are defined as the fixed-shaped target object. Further, the learning model generates and outputs a likelihood map (second likelihood map) associated with each of the two fixed-shaped target objects in response to an input of the reflected wave image.

The likelihood map associated with the “gun” indicates a likelihood with which each pixel of the reflected wave image indicates intensity of a reflected wave reflected on the gun. The likelihood map associated with the “knife” indicates a likelihood with which each pixel of the reflected wave image indicates intensity of a reflected wave reflected on the knife. Note that, in the case of the example in FIG. 7, these fixed-shaped target objects are not carried. Therefore, in both of the likelihood maps, a likelihood with which each pixel of the reflected wave image indicates intensity of a reflected wave reflected on the gun and the knife is lowered.

The likelihood map associated with “blank (nothing)” indicates a likelihood with which nothing is present at a position of each pixel of the reflected wave image.

The likelihood map associated with the “human body” indicates a likelihood with which each pixel of the reflected wave image indicates intensity of a reflected wave reflected on the human body. The likelihood may be computed based on, for example, a shape of a human body, or the like.

The likelihood map (first likelihood map) associated with the “irregularly-shaped target object” indicates a likelihood with which each pixel of the reflected wave image indicates intensity of a reflected wave reflected on the irregularly-shaped target object. In the case of the example in FIG. 7, an irregularly-shaped target object is carried. Therefore, a likelihood indicating intensity of a reflected wave reflected on the irregularly-shaped target object is increased at some pixels of the reflected wave image.

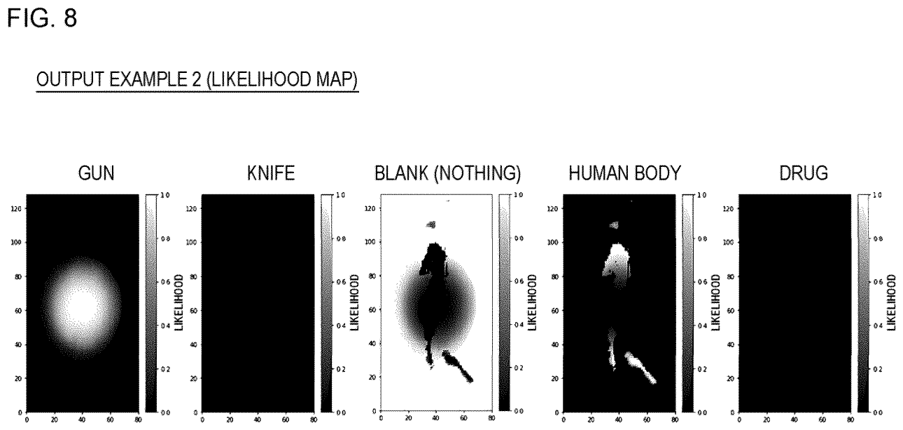

FIG. 8 indicates another example of a likelihood map to be output from the learning model. Also in FIG. 8, as well as FIG. 7, a likelihood of each kind of an associated target object is displayed in black and white shades, an area in which a likelihood is high is indicated in white, and an area in which a likelihood is low is indicated in black. In the example, a gun being a fixed-shaped target object is carried. Therefore, in the likelihood map (second likelihood map) associated with a gun, a likelihood indicating intensity of a reflected wave reflected on the gun is increased at some pixels of the reflected wave image. Note that, in the case of the example in FIG. 8, a knife and an irregularly-shaped target object are not carried. Therefore, in both of the likelihood maps, a likelihood with which each pixel of the reflected wave image indicates intensity of a reflected wave reflected on each of the gun and the irregularly-shaped target object is lowered.

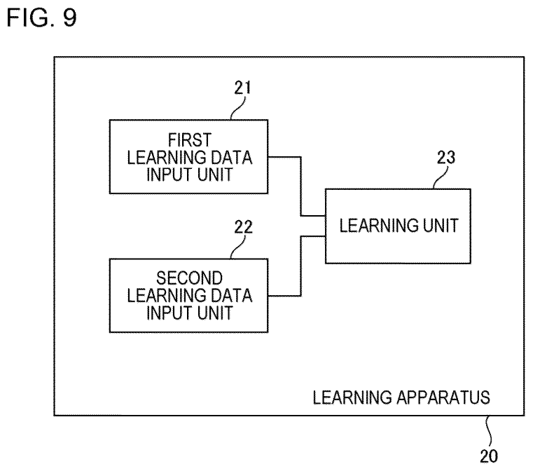

Referring back to FIG. 5, the learning model generation unit 16 generates a learning model as described above, and causes to store the generated learning model in the learning model storage unit 17. The learning model generation unit 16 includes a configuration of a learning apparatus 20 to be described below. As illustrated in FIG. 9, the learning apparatus 20 includes a first learning data input unit 21, a second learning data input unit 22, and a learning unit 23. One example of a hardware configuration of the learning apparatus 20 is illustrated in FIG. 4.

The first learning data input unit 21 inputs, as learning data related to an irregularly-shaped target object, a first learning image, and first correct answer data to the learning apparatus 20.

In the “first learning image”, each pixel indicates intensity (intensity of a reception signal) of a reflected wave of an electromagnetic wave. The first learning image indicates intensity of an electromagnetic wave reflected on an irregularly-shaped target object, and intensity of an electromagnetic wave reflected on a human body carrying the irregularly-shaped target object. In a scene in which the first learning image is generated, an electromagnetic wave is irradiated toward the human body carrying the irregularly-shaped target object, and a reflected wave of the electromagnetic wave is received. Further, the first learning image is generated based on intensity (intensity of the reflected wave of the electromagnetic wave) of a received reception signal.

The “first correct answer data” indicate an area of an irregularly-shaped target object within the first learning image. The first correct answer data may be generated by manual work by a user. Specifically, a user may visually recognize the first learning image, determine an area of the irregularly-shaped target object within the first learning image, and perform an input of specifying the determined area with respect to the learning apparatus 20.

In addition, the first learning data input unit 21 may generate the first correct answer data from the first learning image without manual work by a user as described above. Hereinafter, an example of processing of generating the first correct answer data from the first learning image by the first learning data input unit 21 is described.

### Example 1 of Processing of Generating First Correct Answer Data from First Learning Image

For example, the first learning data input unit 21 detects, from the first learning image, as an area of an irregularly-shaped target object, an area in which a predetermined feature value to be acquired from image intensity (intensity of a reception signal) satisfies a predetermined condition. Further, the first learning data input unit 21 uses a detection result (data indicating the detected area), as the first correct answer data.

The “predetermined feature value” is, for example, permittivity. The first learning data input unit 21 processes the first learning image, and generates a permittivity image in which an influence of a position and the like are corrected. In the permittivity image, permittivity associated with each pixel is indicated. Further, the first learning data input unit 21 detects, as an area of the irregularly-shaped target object, an area in which the permittivity is equal to or less than a threshold value. In this method, an area of an irregularly-shaped target object is detected by utilizing that permittivity of the irregularly-shaped target object is equal to or less than the threshold value.

In addition, the predetermined feature value may be intensity itself of a reception signal indicated by a reflected wave image. In this case, the first learning data input unit 21 detects, as an area of the irregularly-shaped target object, an area in which intensity of a reception signal lies within a predetermined numerical value range (value to be computed based on reflectivity or the like of the irregularly-shaped target object).

### Example 2 of Processing of Generating First Correct Answer Data from First Learning Image

In the example, an electromagnetic wave is irradiated toward a target object by using the above-described electromagnetic wave transmitting and receiving apparatus, a reflected wave of the electromagnetic wave is received, also the target object is photographed by a camera (example: a camera including a sensor that detects visible light), and an image (hereinafter, a “camera image”) is generated. The electromagnetic wave transmitting and receiving apparatus, and the camera are installed at a substantially same position, and capture the target object from a substantially same direction.

The first learning data input unit 21 determines a position of the irregularly-shaped target object within the camera image generated by the camera. Further, the first learning data input unit 21 determines a position within a first learning image associated with the position of the irregularly-shaped target object determined within the camera image, and detects, as an area of the irregularly-shaped target object, the determined position within the first learning image.

As a method of determining a position of an irregularly-shaped target object within a camera image, for example, usage of a marker is exemplified. Specifically, in photographing a human body carrying an irregularly-shaped target object, a marker that clearly indicates a position of the irregularly-shaped target object is caused to be captured in a camera image. The marker may be, for example, a seal of a predetermined mark, or the like. In this case, the seal is attached to the position of the irregularly-shaped target object. Detection of the marker within the camera image is achieved by using a conventional image analysis technique.

Next, processing of detecting an area of an irregularly-shaped target object within a first learning image, based on a position of the irregularly-shaped target object determined within a camera image, is described.

As described above, the camera image and the first learning image are an image in which a human body carrying the irregularly-shaped target object is captured at a substantially same position and from a substantially same direction. Therefore, a relative positional relationship between the human body and the irregularly-shaped target image that are indicated within the camera image becomes equivalent to a relative positional relationship between the human body and the irregularly-shaped target object within the first learning image. The first learning data input unit 21 determines, based on the relationship as described above, a “position within a first learning image” associated with a “position of an irregularly-shaped target object determined within a camera image”. Further, the first learning data input unit 21 sets, as an area of the irregularly-shaped target object within the first learning image, a predetermined area in which the position determined within the first learning image is set as a reference. One example of the predetermined area in which the position determined within the first learning image is set as a reference is a rectangular area in which a determined position is set as a center, but the predetermined area is not limited thereto.

The second learning data input unit 22 inputs, as learning data related to a fixed-shaped target object, a second learning image, and second correct answer data to the learning apparatus 20.

In the “second learning image”, each pixel indicates intensity (intensity of a reception signal) of a reflected wave of an electromagnetic wave. The second learning image indicates intensity of an electromagnetic wave reflected on a fixed-shaped target object, and intensity of an electromagnetic wave reflected on a human body carrying the fixed-shaped target object. In a scene in which the second learning image is generated, an electromagnetic wave is irradiated toward the human body carrying the fixed-shaped target object, and a reflected wave of the electromagnetic wave is received. Further, the second learning image is generated based on intensity (intensity of the reflected wave of the electromagnetic wave) of a received reception signal.

The “second correct answer data” indicate an area of a fixed-shaped target object within the second learning image. The second correct answer data may be generated by manual work by a user. Specifically, a user may visually recognize the second learning image, determine an area of the fixed-shaped target object within the second learning image, and perform an input of specifying the determined area with respect to the learning apparatus 20.

In addition, the second learning data input unit 22 may generate the second correct answer data from the second learning image without manual work by a user as described above.

For example, an electromagnetic wave is irradiated toward a target object by using the above-described electromagnetic wave transmitting and receiving apparatus, a reflected wave of the electromagnetic wave is received, also the target object is photographed by a camera (example: a camera including a sensor that detects visible light), and a camera image is generated. The electromagnetic wave transmitting and receiving apparatus, and the camera are installed at a substantially same position, and capture the target object from a substantially same direction.

The second learning data input unit 22 determines a position of the fixed-shaped target object within the camera image generated by the camera. Further, the second learning data input unit 22 determines a position within the second learning image associated with the position of the fixed-shaped target object determined within the camera image, and detects, as an area of the fixed-shaped target object, the determined position within the second learning image.

As a method of determining a position of a fixed-shaped target object within a camera image, for example, usage of a marker is exemplified. Specifically, in photographing a human body carrying a fixed-shaped target object, a marker that clearly indicates a position of the fixed-shaped target object is caused to be captured in a camera image. The marker may be, for example, a seal of a predetermined mark, or the like. In this case, the seal is attached to the position of the fixed-shaped target object. Detection of the marker within the camera image is achieved by using a conventional image analysis technique.

Next, processing of detecting an area of a fixed-shaped target object within a second learning image, based on a position of the fixed-shaped target object determined within a camera image, is described.

As described above, the camera image and the second learning image are an image acquired by photographing a human body carrying the fixed-shaped target object at a substantially same position and from a substantially same direction. Therefore, a relative positional relationship between the human body and the fixed-shaped target image that are indicated within the camera image becomes equivalent to a relative positional relationship between the human body and the fixed-shaped target object within the second learning image. The second learning data input unit 22 determines, based on the relationship as described above, a “position within a second learning image” associated with a “position of a fixed-shaped target object determined within a camera image”. Further, the second learning data input unit 22 sets, as an area of the fixed-shaped target object within the second learning image, a predetermined area in which the position determined within the second learning image is set as a reference. One example of the predetermined area in which the position determined within the second learning image is set as a reference is a rectangular area in which a determined position is set as a center, but the predetermined area is not limited thereto.

The learning unit 23 generates the above-described learning model by learning based on learning data related to an irregularly-shaped target object being input by the first learning data input unit 21, and learning data related to a fixed-shaped target object being input by the second learning data input unit 22. However, the learning method is not specifically limited.

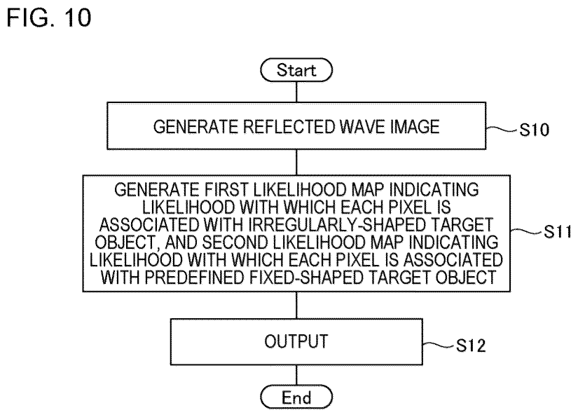

Next, one example of a flow of processing of the target object detection apparatus 10 is described by using a flowchart in FIG. 10.

First, the target object detection apparatus 10 generates a reflected wave image, based on a reception signal of an electromagnetic wave reflected on a target object (S10).

Subsequently, the target object detection apparatus 10 generates a first likelihood map and a second likelihood map, based on the reflected wave image generated in S10 (S11). Specifically, the target object detection apparatus 10 generates, based on intensity of a reception signal indicated by the reflected wave image, the first likelihood map indicating a likelihood with which each pixel of the reflected wave image is associated with an irregularly-shaped target object. Further, the target object detection apparatus 10 generates, based on a shape of an object indicated by the reflected wave image, the second likelihood map indicating a likelihood with which each pixel of the reflected wave image is associated with a predefined fixed-shaped target object.

Then, the target object detection apparatus 10 outputs the generated first likelihood map and second likelihood map (S12). For example, the target object detection apparatus 10 outputs a set of likelihood maps as illustrated in FIG. 7 or 8. The target object detection apparatus 10 performs the output via any output apparatus such as a display, a projection apparatus, or a printer.

### “Advantageous Effect”

In the target object detection apparatus 10 according to the second example embodiment, an advantageous effect similar to that of the target object detection apparatus 10 according to the first example embodiment is achieved. Specifically, in the target object detection apparatus 10 according to the second example embodiment, an irregularly-shaped target object is detected based on intensity of a reception signal indicated by a reflected wave image, by utilizing a difference between reflectivity of an electromagnetic wave of a background object and reflectivity of an electromagnetic wave of the irregularly-shaped target object. Further, a fixed-shaped target object is detected by utilizing a shape of an object indicated by the reflected wave image. In the target object detection apparatus 10 according to the second example embodiment as above, a task of accurately detecting both of a fixed-shaped target object and an irregularly-shaped target object is solved.

Further, the target object detection apparatus 10 according to the second example embodiment generates a first likelihood map and a second likelihood map by using a unique learning model as illustrated in FIG. 2. The learning model generates and outputs both of the first likelihood map and the second likelihood map individually in response to an input of a reflected wave image. A user can confirm presence of an irregularly-shaped target object and a fixed-shaped target object, based on likelihood maps output as illustrated in FIGS. 7 and 8.

Herein, FIG. 3 illustrates a configuration of the comparative example. In the comparative example, two learning models being a first learning model that generates a first likelihood map in response to an input of a reflected wave image, and a second learning model that generates a second likelihood map in response to an input of the reflected wave image are utilized. Specifically, in the comparative example, the first likelihood map and the second likelihood map are generated by using the two learning models. In a case of a configuration of the comparative example as described above, there is a problem such as an increase in resources of a computer. In the target object detection apparatus 10 according to the second example embodiment, the problem as described above can be reduced.

### Third Example Embodiment

A target object detection apparatus 10 according to a third example embodiment determines, based on a first likelihood map, an area of an irregularly-shaped target object within a reflected wave image. Further, the target object detection apparatus 10 determines, based on a second likelihood map, an area of a fixed-shaped target object within the reflected wave image. Further, the target object detection apparatus 10 outputs a determined result. Hereinafter, details are described.

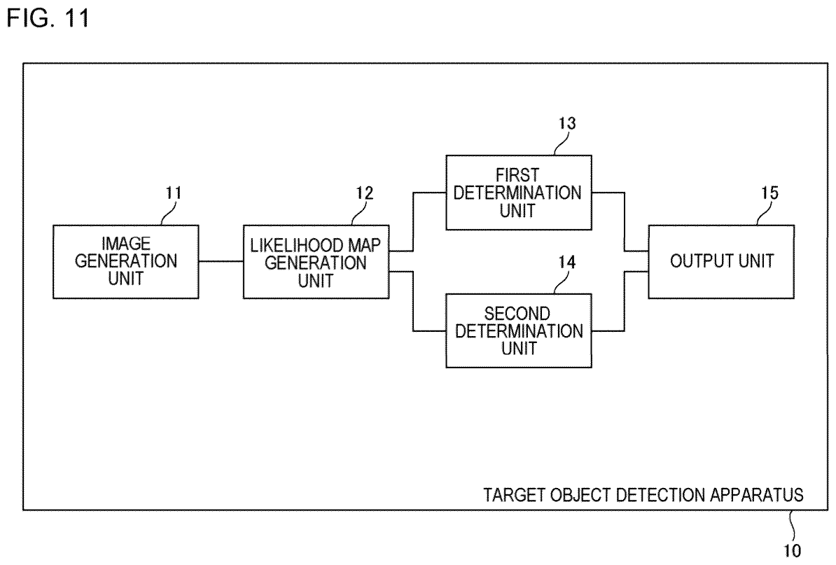

FIG. 11 illustrates one example of a functional block diagram of the target object detection apparatus 10 according to the third example embodiment. As illustrated in FIG. 11, the target object detection apparatus 10 includes an image generation unit 11, a likelihood map generation unit 12, a first determination unit 13, a second determination unit 14, and an output unit 15.

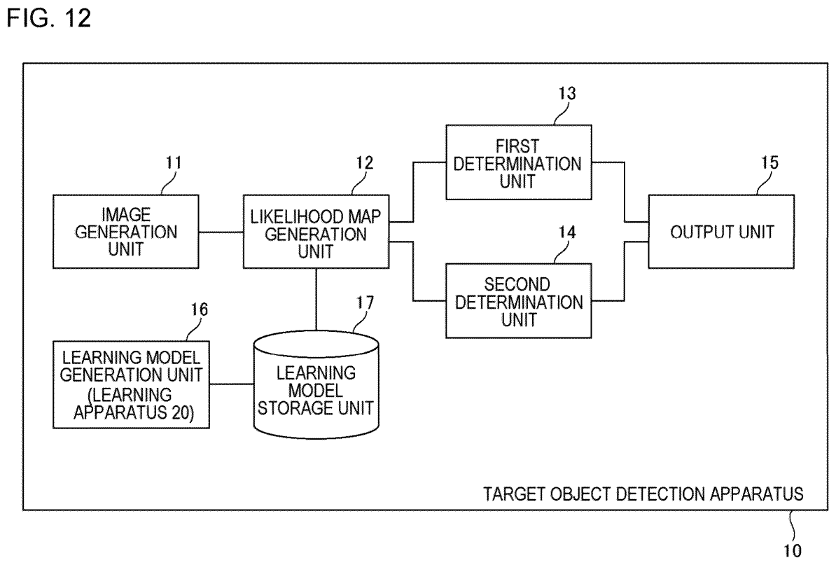

FIG. 12 illustrates another example of a functional block diagram of the target object detection apparatus 10 according to the third example embodiment. As illustrated in FIG. 12, the target object detection apparatus 10 may further include a learning model generation unit 16 and a learning model storage unit 17.

The first determination unit 13 determines, based on a first likelihood map generated by the likelihood map generation unit 12, an area of an irregularly-shaped target object within a reflected wave image. For example, the first determination unit 13 can compare likelihoods of a set of likelihood maps as illustrated in FIG. 7 or 8 with one another for each pixel, and determine, as an area of an irregularly-shaped target object, a group of pixels at which a likelihood associated with the irregularly-shaped target object becomes maximum. As another example, for example, the first determination unit 13 may determine, as an area of the irregularly-shaped target object, a group of pixels at which a likelihood associated with the irregularly-shaped target object indicated by the first likelihood map is equal to or more than a first reference value.

The second determination unit 14 determines, based on a second likelihood map generated by the likelihood map generation unit 12, an area of a fixed-shaped target object within the reflected wave image. For example, the second determination unit 14 can compare likelihoods of a set of likelihood maps as illustrated in FIG. 7 or 8 with one another for each pixel, and determine, as an area of a fixed-shaped target object, a group of pixels at which a likelihood associated with the fixed-shaped target object becomes maximum.

As another example, the second determination unit 14 can determine, as an area of the fixed-shaped target object, a group of pixels at which a likelihood associated with the fixed-shaped target object indicated by the second likelihood map is equal to or more than a second reference value. The above-described first reference value and the second reference value may be the same value, or may be a different value.

As another example, the second determination unit 14 may determine, as a position of a fixed-shaped target object, a pixel at which a likelihood associated with the fixed-shaped target object indicated by the second likelihood map becomes a local maximum value, and a value of the likelihood is equal to or more than a third reference value. Further, the second determination unit 14 may determine, as an area of the fixed-shaped target object, a predetermined area in which the determined pixel is a reference. The “pixel at which a likelihood becomes a local maximum value” is a pixel at which a likelihood is higher than that at a peripheral pixel. The “predetermined area in which the determined pixel is a reference” is, for example, a rectangular area in which the determined pixel is a center, but is not limited thereto.

The output unit 15 generates and outputs a first image and a second image.

The “first image” indicates an area of the irregularly-shaped target object within the reflected wave image determined by the first determination unit 13. The “second image” indicates an area of the fixed-shaped target image within the reflected wave image determined by the second determination unit 14.

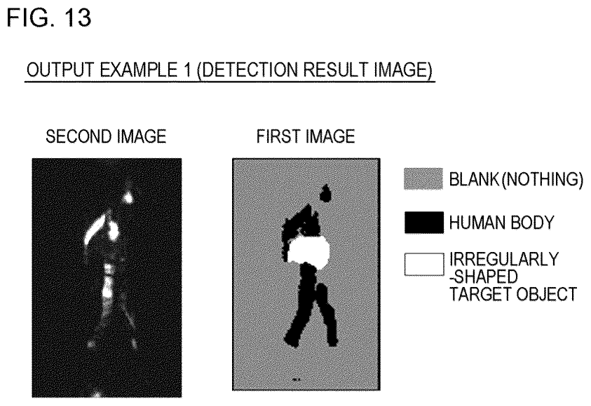

FIG. 13 illustrates one example of the first image and the second image output from the output unit 15. The first image and the second image in FIG. 13 are an image generated based on a set of likelihood maps illustrated in FIG. 7.

The first image illustrated in FIG. 13 is generated, from among a set of likelihood maps illustrated in FIG. 7, based on three likelihood maps associated with “blank (nothing)”, a “human body”, and an “irregularly-shaped target object”. The output unit 15 compares likelihoods of each of the above-described three likelihood maps with one another for each pixel, and allocates, to each pixel, a kind (blank (nothing), a human body, and an irregularly-shaped target object) in which a likelihood becomes maximum. Further, the output unit 15 generates the first image as illustrated in FIG. 13 by displaying each pixel by a method (a color or the like) associated with the allocated kind.

The second image illustrated in FIG. 13 is generated by displaying, in a superimposing manner, on a reflected wave image generated by the image generation unit 11, information indicating an area of a fixed-shaped target object determined by the second determination unit 14. Note that, in the example of a set of likelihood maps illustrated in FIG. 7, a fixed-shaped target object is not carried. Therefore, in the second image in FIG. 13, the reflected wave image is displayed as it is, and information indicating an area of the fixed-shaped target object is not displayed.

Note that, as a modification example, in a case where a fixed-shaped target object is not detected as described above, information indicating the above may be displayed on the second image. For example, any text information such as “not detected”, “non-detection”, or “OK” may be displayed, or any mark or figure may be displayed.

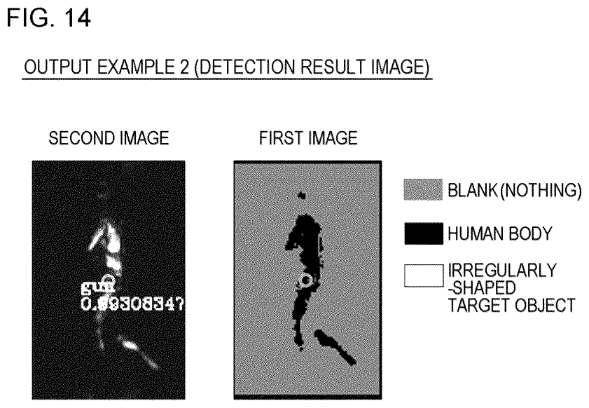

FIG. 14 illustrates another example of the first image and the second image output from the output unit 15. The first image and the second image in FIG. 14 are an image generated based on a set of likelihood maps illustrated in FIG. 8.

The first image illustrated in FIG. 14 is generated, from among a set of likelihood maps illustrated in FIG. 8, based on three likelihood maps associated with “blank (nothing)”, a “human body”, and an “irregularly-shaped target object”. The output unit 15 compares likelihoods of each of the above-described three likelihood maps with one another for each pixel, and allocates, to each pixel, a kind (blank (nothing), a human body, and an irregularly-shaped target object) in which a likelihood becomes maximum. Further, the output unit 15 generates the first image as illustrated in FIG. 14 by displaying each pixel by a method (a color or the like) associated with the allocated kind. Note that, in the example of a set of likelihood maps illustrated in FIG. 8, an irregularly-shaped target object is not carried. Therefore, in the first image in FIG. 14, an area of the irregularly-shaped target object is not indicated.

Note that, as a modification example, in a case where an irregularly-shaped target object is not detected as described above, information indicating the above may be displayed on the first image. For example, any text information such as “not detected”, “non-detection”, or “OK” may be displayed, or any mark or figure may be displayed.

The second image illustrated in FIG. 14 is generated by displaying, in a superimposing manner, on a reflected wave image generated by the image generation unit 11, information indicating an area of a fixed-shaped target object determined by the second determination unit 14. In the example of a set of likelihood maps illustrated in FIG. 8, a gun being the fixed-shaped target object is carried. Therefore, in the second image in FIG. 14, information indicating that a gun is detected, and a frame indicating a position of the gun are displayed, in a superimposing manner, on the reflected wave image.

Although not illustrated, as a modification example, as well as a second image, a first image may be generated by displaying, in a superimposing manner, on a reflected wave image, information indicating an area of an irregularly-shaped target object determined by the first determination unit 13. Further, the second image may be generated by displaying, in a superimposing manner, on a figure indicating a human body area as exemplified by the first image, information indicating an area of a fixed-shaped target object determined by the second determination unit 14.

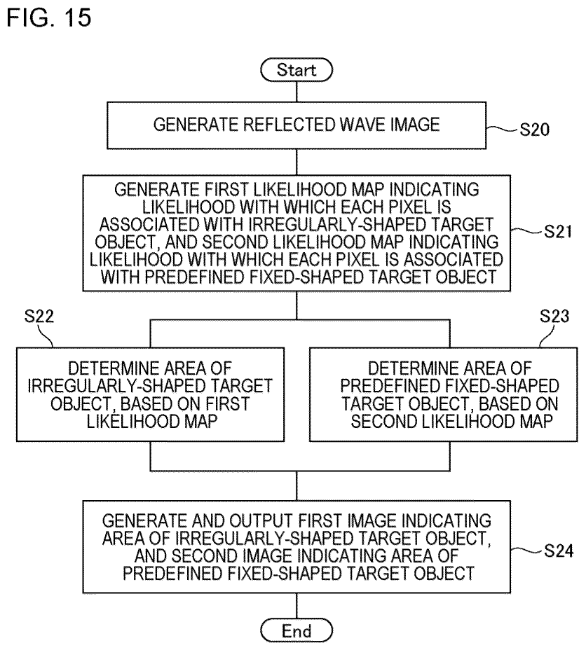

Next, one example of a flow of processing of the target object detection apparatus 10 is described by using a flowchart in FIG. 15.

First, the target object detection apparatus 10 generates a reflected wave image, based on a reception signal of an electromagnetic wave reflected on a target object (S20).

Subsequently, the target object detection apparatus 10 generates a first likelihood map and a second likelihood map, based on the reflected wave image generated in S10 (S21). Specifically, the target object detection apparatus 10 generates, based on intensity of a reception signal indicated by the reflected wave image, the first likelihood map indicating a likelihood with which each pixel of the reflected wave image is associated with an irregularly-shaped target object. Further, the target object detection apparatus 10 generates, based on a shape of an object indicated by the reflected wave image, the second likelihood map indicating a likelihood with which each pixel of the reflected wave image is associated with a predefined fixed-shaped target object.

Subsequently, the target object detection apparatus 10 determines, based on the first likelihood map generated in S21, an area of the irregularly-shaped target object within the reflected wave image generated in S20 (S22). Further, the target object detection apparatus 10 determines, based on the second likelihood map generated in S21, an area of the fixed-shaped target object within the reflected wave image generated in S20 (S23).

Subsequently, the target object detection apparatus 10 generates and outputs a first image indicating the area of the irregularly-shaped target object determined in S22, and a second image indicating the area of the fixed-shaped target object determined in S23 (S24).

Other configurations of the target object detection apparatus 10 according to the third example embodiment are similar to the configurations of the target object detection apparatus 10 according to the first and second example embodiments.

In the target object detection apparatus 10 according to the third example embodiment, an advantageous effect similar to that of the target object detection apparatus 10 according to the first and second example embodiments is achieved.

Further, the target object detection apparatus 10 according to the third example embodiment generates and outputs a first image indicating a position of an irregularly-shaped target object, and a second image indicating a position of a fixed-shaped target object. A user can immediately recognize, based on the first image and the second image as described above, whether an irregularly-shaped target object and a fixed-shaped target object are detected.

Further, a user can immediately recognize, based on the first image and the second image as described above, a position of a detected irregularly-shaped target object and fixed-shaped target object.

### Modification Example

While the target object detection apparatus 10 in the second example embodiment includes the learning model generation unit 16, a target object detection apparatus 10 may not include a learning model generation unit 16. In this case, an external apparatus being physically and/or logically separated from the target object detection apparatus 10 includes the learning model generation unit 16. Further, a learning model generated by the external apparatus is stored in a learning model storage unit 17 by any means.

In the foregoing, example embodiments according to the present invention have been described with reference to the drawings, however, these are examples of the present invention, and various configurations other than the above can also be adopted. The configurations of the above-described example embodiments may be combined with each other, or some configurations may be interchanged with another configuration. Further, various changes may be added to the configuration of the above-described example embodiments within a range that does not depart from the gist of the invention. Further, a configuration and processing disclosed in the above-described each example embodiment and modification example may be combined with each other.

Further, in a plurality of flowcharts used in the above description, a plurality of processes (pieces of processing) are described in order. However, the order of execution of processes to be performed in each example embodiment is not limited to the order of description. In each example embodiment, the illustrated order of processes can be changed within a range that does not adversely affect a content. Further, the above-described example embodiments can be combined, as far as contents do not conflict with each other.

A part or all of the above-described example embodiments may also be described as the following supplementary notes, but is not limited to the following.

1. A target object detection apparatus including:
an image generation unit that generates a reflected wave image, based on a reception signal of an electromagnetic wave reflected on a target object; and
a likelihood map generation unit that generates, based on intensity of the reception signal indicated by the reflected wave image, a first likelihood map indicating a likelihood with which each pixel of the reflected wave image is associated with an irregularly-shaped target object that shields a background object and whose reflectivity of an electromagnetic wave is different from that of the background object, and also generates, based on a shape of an object indicated by the reflected wave image, a second likelihood map indicating a likelihood with which each pixel of the reflected wave image is associated with a predefined fixed-shaped target object.
   2. The target object detection apparatus according to supplementary note 1, further including:
a first determination unit that determines an area of the irregularly-shaped target object, based on the first likelihood map; and
a second determination unit that determines an area of the fixed-shaped target object, based on the second likelihood map.
   3. The target object detection apparatus according to supplementary note 2, further including
an output unit that generates and outputs a first image indicating a determined area of the irregularly-shaped target object, and a second image indicating a determined area of the fixed-shaped target object.
   4. The target object detection apparatus according to any one of supplementary notes 1 to 3, wherein
the likelihood map generation unit
   generates the first likelihood map and the second likelihood map, based on a learning model that outputs both of the first likelihood map and the second likelihood map in response to an input of the reflected wave image.
      5. The target object detection apparatus according to supplementary note 4, further including:
a first learning data input unit that inputs, as learning data related to the irregularly-shaped target object, a first learning image, and first correct answer data indicating an area of the irregularly-shaped target object within the first earning image;
a second learning data input unit that input, as learning data related to the fixed-shaped target object, a second learning image, and second correct answer data indicating an area of the fixed-shaped target object within the second learning image; and
a learning unit that generates the learning model, based on learning data related to the irregularly-shaped target object, and learning data related to the fixed-shaped target object.
   6. The target object detection apparatus according to supplementary note 5, wherein
the first learning data input unit
   detects, from the first learning image, as an area of the irregularly-shaped target object, an area in which a predetermined feature value to be acquired from image intensity satisfies a predetermined condition, and uses a detection result, as the first correct answer data.
      7. The target object detection apparatus according to supplementary note 5 or 6, wherein
the first learning data input unit
   detects an area of the irregularly-shaped target object within the first learning image, based on a position of the irregularly-shaped target object determined within an image generated by a camera, and uses a detection result, as the first correct answer data.
      8. The target object detection apparatus according to any one of supplementary notes 5 to 7, wherein
the second learning data input unit
   detects an area of the fixed-shaped target object within the second learning image, based on a position of the fixed-shaped target object determined within an image generated by a camera, and uses a detection result, as the second correct answer data.
      9. The target object detection apparatus according to any one of supplementary notes 1 to 8, wherein
the irregularly-shaped target object includes liquid matter or powder matter.
   10. The target object detection apparatus according to any one of supplementary notes 1 to 9, wherein
the background object is a human body.
   11. The target object detection apparatus according to any one of supplementary notes 1 to 10, wherein
the fixed-shaped target object includes a gun, a knife, or a weapon.
   12. A target object detection method including,
by one or more computers:
   generating a reflected wave image, based on a reception signal of an electromagnetic wave reflected on a target object; and
   generating, based on intensity of the reception signal indicated by the reflected wave image, a first likelihood map indicating a likelihood with which each pixel of the reflected wave image is associated with an irregularly-shaped target object that shields a background object and whose reflectivity of an electromagnetic wave is different from that of the background object, and also generates, based on a shape of an object indicated by the reflected wave image, a second likelihood map indicating a likelihood with which each pixel of the reflected wave image is associated with a predefined fixed-shaped target object.
      13, A program that causes a computer to function as:
an image generation unit that generates a reflected wave image, based on a reception signal of an electromagnetic wave reflected on a target object; and
a likelihood map generation unit that generates, based on intensity of the reception signal indicated by the reflected wave image, a first likelihood map indicating a likelihood with which each pixel of the reflected wave image is associated with an irregularly-shaped target object that shields a background object and whose reflectivity of an electromagnetic wave is different from that of the background object, and also generates, based on a shape of an object indicated by the reflected wave image, a second likelihood map indicating a likelihood with which each pixel of the reflected wave image is associated with a predefined fixed-shaped target object.

This application is based upon and claims the benefit of priority from Japanese patent application No. 2022-197899, filed on Dec. 12, 2022, the disclosure of which is incorporated herein in its entirety by reference.

### REFERENCE SIGNS LIST

10 Processing apparatus
11 Image generation unit
12 Likelihood map generation unit
13 First determination unit
14 Second determination unit
15 Output unit
16 Learning model generation unit
17 Learning model storage unit
20 Learning apparatus
21 First learning data input unit
22 Second learning data input unit
23 Learning unit
1A Processor
2A Memory
3A Input/output I/F
4A Peripheral circuit
5A Bus

What is claimed is:

1. A target object detection apparatus comprising:
at least one memory configured to store one or more instructions; and
at least one processor configured to execute the one or more instructions to:
generate a reflected wave image, based on a reception signal of an electromagnetic wave reflected on a target object; and
generate, based on intensity of the reception signal indicated by the reflected wave image, a first likelihood map indicating a likelihood with which each pixel of the reflected wave image is associated with an irregularly-shaped target object that shields a background object and whose reflectivity of an electromagnetic wave is different from that of the background object, and also generate, based on a shape of an object indicated by the reflected wave image, a second likelihood map indicating a likelihood with which each pixel of the reflected wave image is associated with a predefined fixed-shaped target object.

2. The target object detection apparatus according to claim 1, wherein the at least one processor is further configured to execute the one or more instructions to
determine an area of the irregularly-shaped target object, based on the first likelihood map; and
a determine an area of the fixed-shaped target object, based on the second likelihood map.

3. The target object detection apparatus according to claim 2, wherein the at least one processor is further configured to execute the one or more instructions to
generate and output a first image indicating a determined area of the irregularly-shaped target object, and a second image indicating a determined area of the fixed-shaped target object.

4. The target object detection apparatus according to claim 1, wherein
the at least one processor is further configured to execute the one or more instructions to
generate the first likelihood map and the second likelihood map, based on a learning model that outputs both of the first likelihood map and the second likelihood map in response to an input of the reflected wave image.

5. The target object detection apparatus according to claim wherein the at least one processor is further configured to execute the one or more instructions to
input, as learning data related to the irregularly-shaped target object, a first learning image, and first correct answer data indicating an area of the irregularly-shaped target object within the first earning image;
a input, as learning data related to the fixed-shaped target object, a second learning image, and second correct answer data indicating an area of the fixed-shaped target object within the second learning image; and
generate the learning model, based on learning data related to the irregularly-shaped target object and learning data related to the fixed-shaped target object.

6. The target object detection apparatus according to claim 5, wherein
the at least one processor is further configured to execute the one or more instructions to
detect, from the first learning image, as an area of the irregularly-shaped target object, an area in which a predetermined feature value to be acquired from image intensity satisfies a predetermined condition, and uses use a detection result, as the first correct answer data.

7. The target object detection apparatus according to claim 5, wherein
the at least one processor is further configured to execute the one or more instructions to
detect an area of the irregularly-shaped target object within the first learning image, based on a position of the irregularly-shaped target object determined within an image generated by a camera, and use a detection result, as the first correct answer data.

8. The target object detection apparatus according to claim 5, wherein
the the at least one processor is further configured to execute the one or more instructions to
detect an area of the fixed-shaped target object within the second learning image, based on a position of the fixed-shaped target object determined within an image generated by a camera, and use a detection result, as the second correct answer data.

9. The target object detection apparatus according to claim 1, wherein
the irregularly-shaped target object includes liquid matter or powder matter.

10. The target object detection apparatus according to claim 1, wherein
the background object is a human body.

11. The target object detection apparatus according to claim 1, wherein
the fixed-shaped target object includes a gun, a knife, or a weapon.

12. A target object detection method comprising,
by one or more computers:
generating a reflected wave image, based on a reception signal of an electromagnetic wave reflected on a target object; and
generating, based on intensity of the reception signal indicated by the reflected wave image, a first likelihood map indicating a likelihood with which each pixel of the reflected wave image is associated with an irregularly-shaped target object that shields a background object and whose reflectivity of an electromagnetic wave is different from that of the background object, and also generates, based on a shape of an object indicated by the reflected wave image, a second likelihood map indicating a likelihood with which each pixel of the reflected wave image is associated with a predefined fixed-shaped target object.

13. The target object detection method according to claim 12, further comprising,
by the one or more computers:
determining an area of the irregularly-shaped target object, based on the first likelihood map; and
determining an area of the fixed-shaped target object, based on the second likelihood map.

14. The target object detection method according to claim 13, further comprising,
by the one or more computers,
generating and outputting a first image indicating a determined area of the irregularly-shaped target object, and a second image indicating a determined area of the fixed-shaped target object.

15. The target object detection method according claim 12, further comprising,
by the one or more computers,
generating the first likelihood map and the second likelihood map, based on a learning model that outputs both of the first likelihood map and the second likelihood map in response to an input of the reflected wave image.

16. The target object detection method according to claim 15, further comprising,
by the one or more computers:
inputting, as learning data related to the irregularly-shaped target object, a first learning image, and first correct answer data indicating an area of the irregularly-shaped target object within the first earning image;
inputting, as learning data related to the fixed-shaped target object, a second learning image, and second correct answer data indicating an area of the fixed-shaped target object within the second learning image; and
generating the learning model, based on learning data related to the irregularly-shaped target object and learning data related to the fixed-shaped target object.

17. A non-transitory computer-readable medium recording a program that causes a computer to:
generate a reflected wave image, based on a reception signal of an electromagnetic wave reflected on a target object; and
generate, based on intensity of the reception signal indicated by the reflected wave image, a first likelihood map indicating a likelihood with which each pixel of the reflected wave image is associated with an irregularly-shaped target object that shields a background object and whose reflectivity of an electromagnetic wave is different from that of the background object, and also generate, based on a shape of an object indicated by the reflected wave image, a second likelihood map indicating a likelihood with which each pixel of the reflected wave image is associated with a predefined fixed-shaped target object.

18. The non-transitory computer-readable medium according to claim 17 that causes the computer to:
determine an area of the irregularly-shaped target object, based on the first likelihood map; and
a second determine an area of the fixed-shaped target object, based on the second likelihood map.

19. The non-transitory computer-readable medium according to claim 18 that causes the computer to:
generate and output a first image indicating a determined area of the irregularly-shaped target object, and a second image indicating a determined area of the fixed-shaped target object.

20. The non-transitory computer-readable medium according to claim 17 that causes the computer to,
generate the first likelihood map and the second likelihood map, based on a learning model that outputs both of the first likelihood map and the second likelihood map in response to an input of the reflected wave image.
